(19) United States
(12) Patent Application Publication
(10) Pub. No.: US 2024/0153015 A1
(43) Pub. Date: May 9, 2024

(54) APPARATUS AND METHOD FOR SOCIAL MEDIA DATA ANALYSIS

(71) Applicant: Viral Nation Inc., Mississauga (CA)

(72) Inventors: Mathew Joseph Ernest Micheli, Ontario (CA); Vikash Rai, Christ Church (BB)

(73) Assignee: Viral Nation Inc., Mississauga, ON (CA)

(21) Appl. No.: 18/283,501

(22) PCT Filed: Mar. 28, 2022
(86) PCT No.: PCT/CA2022/050462

§ 371 Date: Sep. 22, 2023

Related U.S. Application Data
(60) Provisional application No. 63/166,863, filed on Mar. 26, 2021.
(60) Provisional application No. 63/190,129, filed on May 18, 2021.

(51) Int. Cl. G06Q 50/00; H04L 67/306

(52) U.S. Cl. CPC G06Q 50/01; H04L 67/306

(57) ABSTRACT

A computer-implemented method of analyzing data from social media includes receiving, by a computer, a reference to a social media profile; collecting data about the social media profile; processing the data on the computer using an algorithm; generating a report of results of said processing; and communicating the report to a user. A method for conducting a search of social media profiles includes indexing one or more social media profiles, including storing data associated with each of the profiles in a relational database of a computer; establishing a communication link with a user device; receiving, from a user, a query; processing the query, including compiling a subset of the data, the subset being selected and ranked according to their relevance to the query; and preparing a list of profiles from the subset; and communicating the list to the user device.

### BENEFIT OF EARLIER APPLICATIONS

This application claims priority from U.S. provisional application 63/166,863, filed Mar. 26, 2021, and U.S. provisional application 63/190,129, filed May 18, 2021.

### TECHNICAL FIELD

The present invention relates to data analysis in general, and analyzing data from social media in particular.

### BACKGROUND

Social media and similar ephemeral messaging and content posting or publication platform systems make available to the public or subscriber/invitee audiences content in a variety of different forms and formats, structures and interfaces, which is posted, published or made available on one or more of the platforms. While content posted may be anonymous or pseudonymous, often the postings are tagged or identified with an individual. A business has evolved where individuals seek to post content with a view to gaining large viewer audiences, and thereby the individuals can become influencers of tastes, preferences, fashion, thought, or other subjects. These influencers may arrive at a large viewer-count status by their social media status, by another or other methods of becoming famous (such as sports, movie, music or other celebrity), etc. Once an individual influencer has reached a large number of followers, that individual may be paid by a third party to advance the interests of the third party, by influencing followers' purchasing or other behaviors. The third party may thereby attempt to enhance its reputation or brand. Influencer posting behaviors may be irregular or unpredictable, and have been difficult for third parties, and particularly for sponsors, to easily monitor.

Businesses often use social media as a marketing tool. In many cases, businesses consider social media to be their primary marketing tool, and use social media instead of or in addition to their business website. Social media platforms include, by way of illustrative example and without limitation, Instagram™, Twitter™, Pinterest™, and Facebook™. Now more than ever, consumers are making their purchase decisions based on a brand's social media activity, in many cases caring little about the business' website until the time of purchase or contact. 70% of consumers look to Instagram™ for product discovery. 81% of people use Instagram™ to help research products and services. 81% of people use Instagram™ to help research products and services. 130 million Instagram™ users tap on shopping posts every month. 90% of Instagram users follow at least one business.

When websites first became widely used, Google™ and other search engines became popular among consumers as means to organize, sort, locate, and discover websites around the world. Nowadays, as social media is becoming more important than traditional business websites, there is a demand for apparatus and methods for conducting a search of social media.

At present, search engines like Google™ are capable of searching traditional websites, but they are generally unable to do so for many social media activities.

### SUMMARY OF INVENTION

In accordance with a broad aspect of the present invention, there is provided a computer-implemented method of analyzing data from social media, comprising: receiving, by a computer, a reference to a social media profile; collecting data about the social media profile; processing the data on the computer using an algorithm; generating a report of results of said processing; and communicating the report to a user.

In accordance with another broad aspect of the present invention, there is provided a method for conducting a search of social media profiles, comprising: indexing one or more social media profiles, including storing data associated with each of the profiles in a relational database of a computer; establishing a communication link with a user device; receiving, from a user, a query; processing the query, including compiling a subset of the data, the subset being selected and ranked according to their relevance to the query; and preparing a list of profiles from the subset, the list including a hyperlink to each profile of the list of profiles; and communicating the list to the user device.

In accordance with yet another broad aspect of the present invention, there is provided a system for analyzing data from social media, comprising: a computer for receiving a reference to a social media profile; the computer being configured to collect data about the social media profile, process the data using an algorithm, generate a report of results of said process; establishing a communication link to a user device; and communicating the report to the user device via the communication link.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all within the present invention. Furthermore, the various embodiments described may be combined, mutatis mutandis, with other embodiments described herein. Accordingly, the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

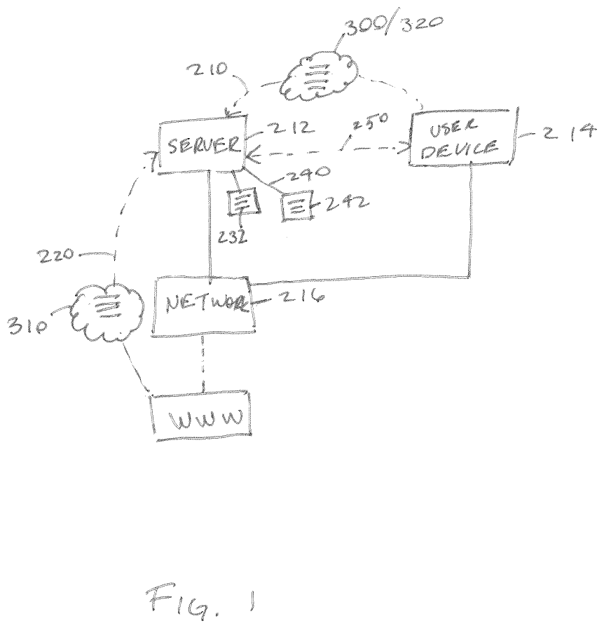

(a) FIG. 1 is an architecture diagram according to one embodiment of the present invention;

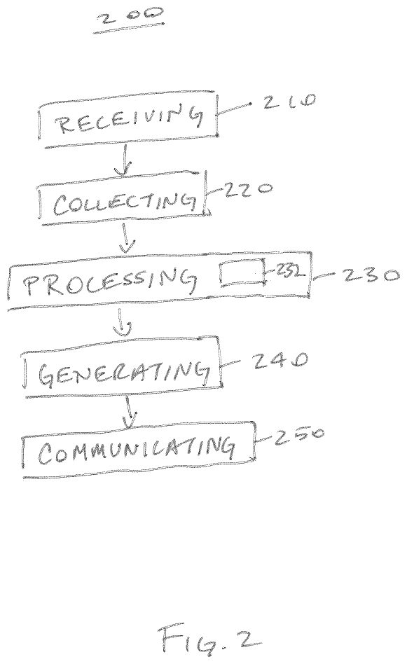

(b) FIG. 2 is a flow diagram of a method of analyzing data from social media, according to the embodiment of FIG. 1;

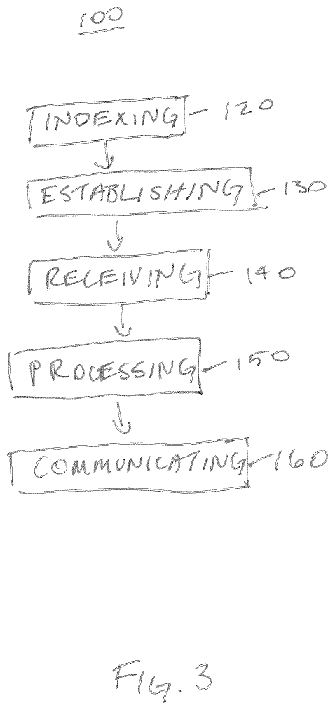

(c) FIG. 3 is a flow diagram of a method for indexing social media activity, according to another embodiment;

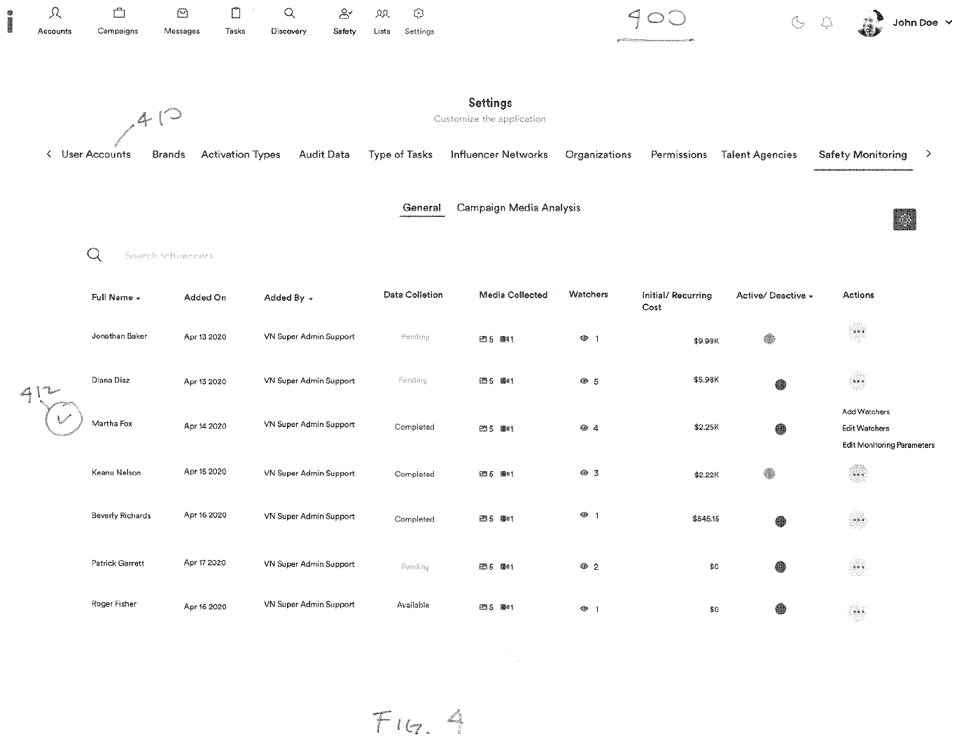

(d) FIG. 4 is a diagram of a user interface including an accounts section tab and a badge, according to one embodiment;

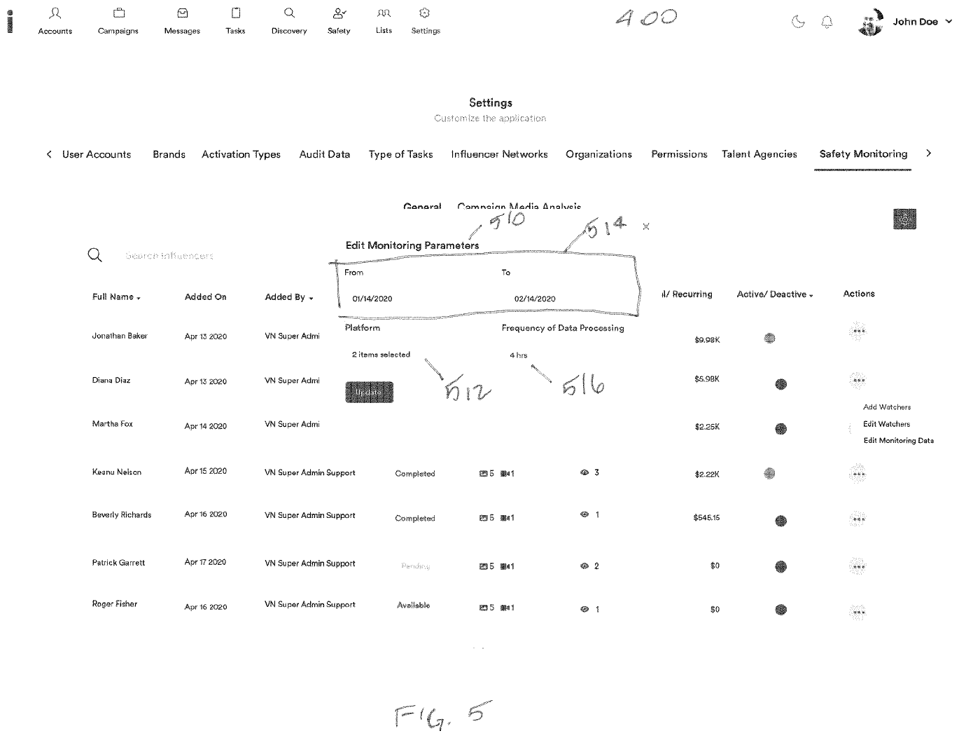

(e) FIG. 5 is a diagram of a user interface including customizable monitoring parameters, according to one embodiment;

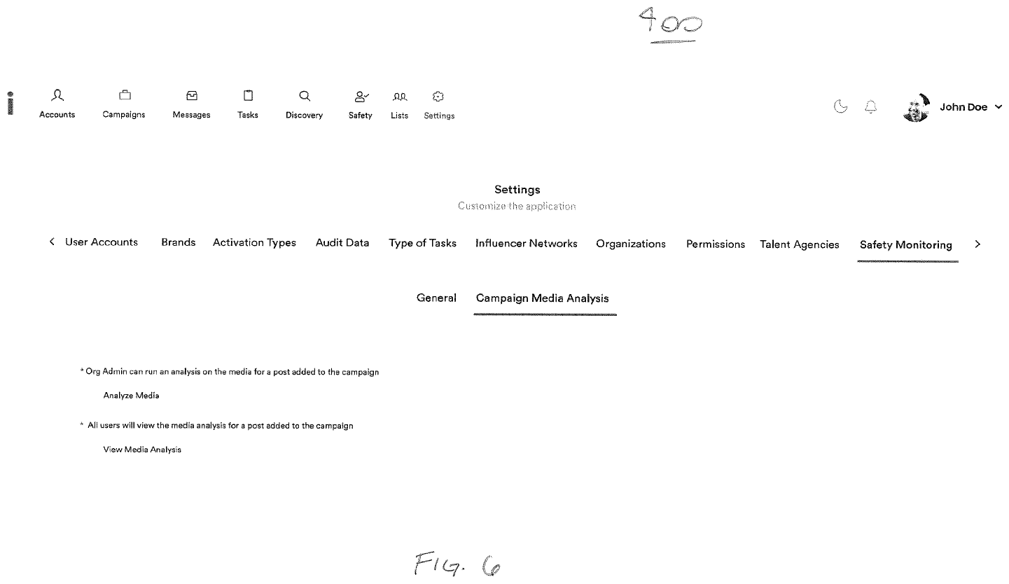

(f) FIG. 6 is a diagram of a user interface including user settings options, according to one embodiment;

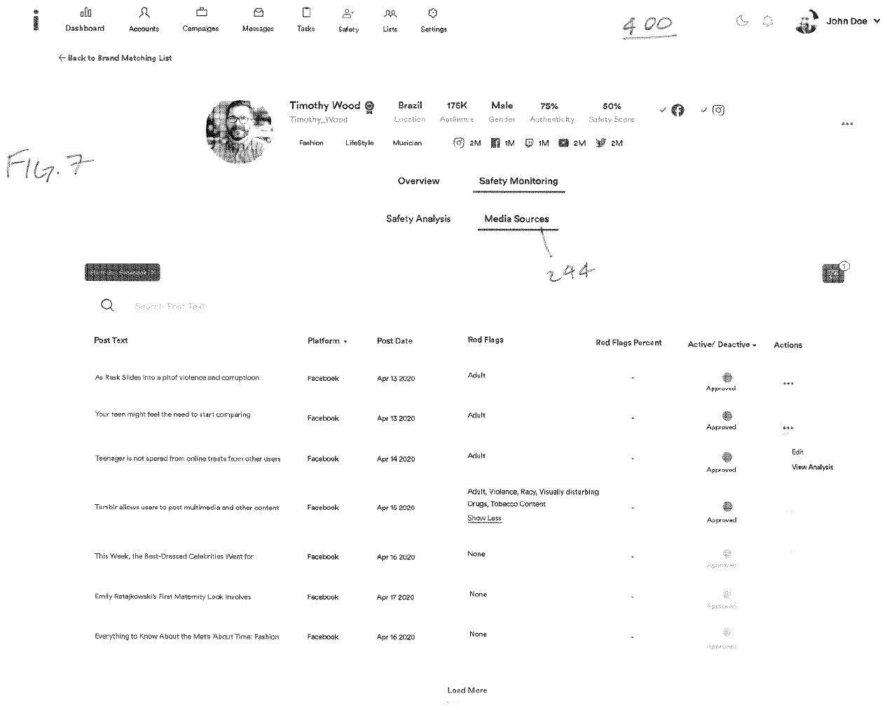

(g) FIG. 7 is a diagram of a user interface including a list of media sources, according to one embodiment;

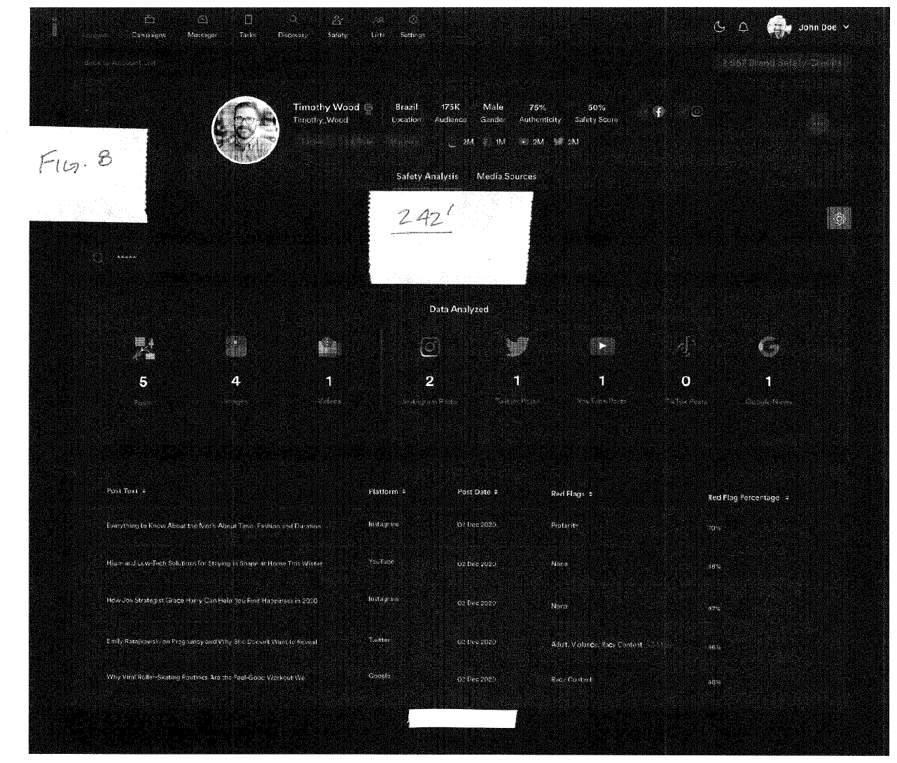

(h) FIG. 8 is a diagram of a safety analysis report according to one embodiment;

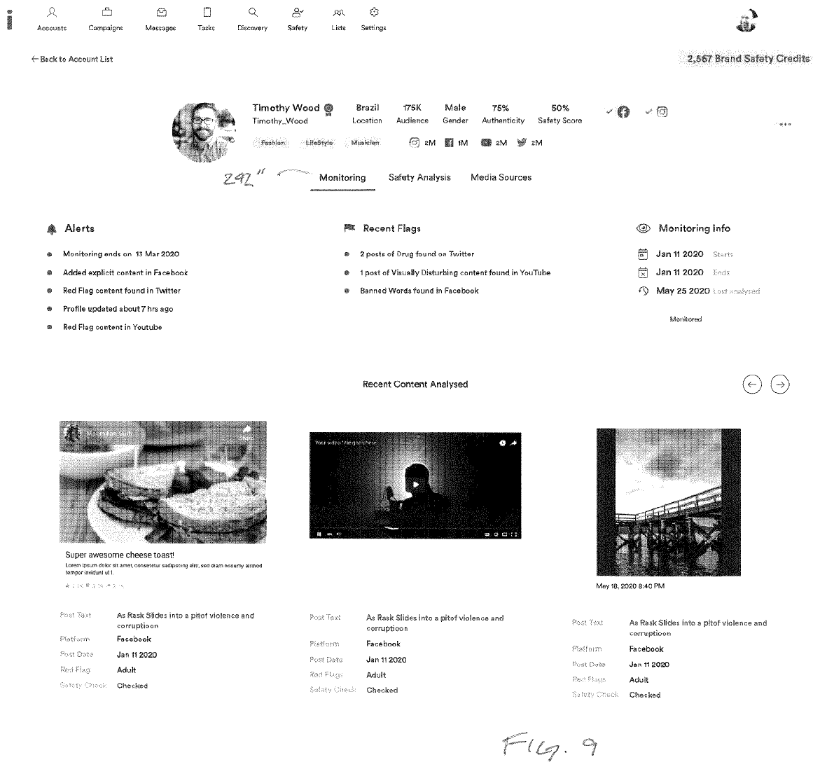

(i) FIG. 9 is a diagram of a monitoring report according to another embodiment; and

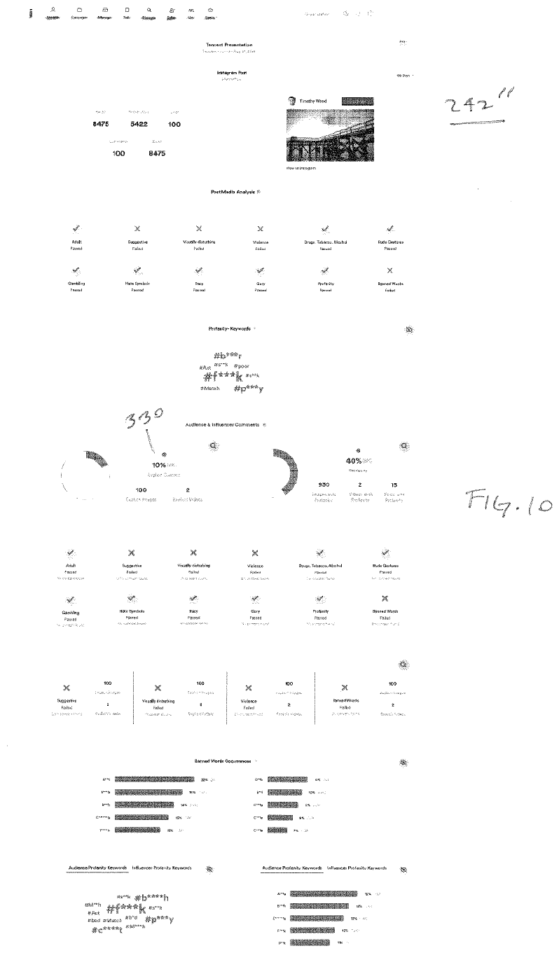

(j) FIG. 10 is a diagram of a monitoring report according to yet another embodiment.

### DETAILED DESCRIPTION OF EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

In one embodiment, there is provided a system and method for finding, characterizing, ranking, and/or monitoring social media posts, behaviors, profiles and/or influencers, which may include social media background checking.

The present invention, in one aspect, may relate to brand and safety monitoring of posts and messages in the public internet in general, for example, for users/customers in aid of protecting or enhancing the users'/customers' branding. Further and other example use cases and process steps or system elements are described below, by way of illustration and not limitation.

Sometimes, influencers may post content that is not suitable for the message or reputation that a third party desires to be associated with its brand or reputation or is otherwise unsuitable. The invention of this disclosure may include a system to locate and characterize influencer posts for monitoring ‘fit’ (or lack of fit, non-compliance with contractual terms, or other unwanted post characteristics or patterns of characteristics) within one of more categories of concern, with a preset optimum. It may be used to perform a sort of social media background check.

Sometimes, influencers may post content, which is not suitable for the message, or reputation that the third party desires to be associated with its brand or reputation. It has previously been difficult to locate and characterize influencer posts for monitoring ‘fit’ (or lack of fit, non-compliance with contractual terms, or other unwanted post characteristics or patterns of characteristics) with the brand or reputation; or to provide a type of social media background check (as an example).

The method and apparatus of this invention may include one or more of the following:
(a) A computer
(b) An interface for a third party;
(c) At least one search mechanism to find and get a link to at least one influencer post of content or to at least one post with content about an influencer;
(d) At least one content analysis mechanism to characterize the content using categories previously selected by the third party using the third party interface, providing a content characterization;
(e) A comparator to compare the content characterization with criteria selected by the third party to provide a score indicative of some measure of the criteria found in the analyzed content;
(f) An output from the comparator comprising a feedback to the third party indicative of the degree of fit between the content characterization score obtained by the comparator with a score preselected by the third party which preselected score might be, for example, an idealized score or an acceptable range limit or an unacceptable range limit of scores within that category of characterization, which was preselected by the third party using the interface;
(g) One or more of a content analysis mechanism, category description and associated filter or search parameters, scoring means, means to determine degree of fit or idealized score or range limit of score, may be done by or augmented by artificial intelligence, machine learning processes, or similar systems and methods. In the illustrated embodiment of FIG. 5, such parameters 510 include selected platforms 512, a range 514 of dates for posts, and a frequency 516 of processing.

The method may be computer implemented. The apparatus may include a computer.

The following covers example workflow and measurements within this system of the invention. For purposes of this discussion, an “influencer” may also have any other role, and may also be any of the other parties discussed.

### Example Use-Cases

Some example use cases for the system may include one or more of:
(a) A third party customer may be an employer auditing a potential or current employee. This could also apply when hiring or vetting people that may be in positions of trust. E.g., a police officer or coach who is working with youth.
(b) The third party may want to obtain a reliable type of social media background check and/or report.
(c) The third party may be a governmental authority wanting to vet employees, office holders or persons of interest.
(d) A third party may own or manage a brand, and may wish to obtain a report on a potential contractor, such as an influencer or celebrity, prior to contracting same for an endorsement or marketing engagement. The system may display a safety score, which may be a percentage, based off of one or more (for example, dozens of) criteria to determine how safe this influencer or user is, which may be computed by an algorithm.
(e) Based on the profile of a celebrity, influencer or individual, the system may provide an objective score, which may be used to predict the risk of that influencer or individual to post something undesirable in the future.
(f) Using the system, it may be possible to run a consistent monitoring program, auditing all content that a user selected influencer posts going forward in time, and notifying the user, if there are any categories with scored characterizations outside of score thresholds or limits or ranges that the system would detect. (This feature might be used by a third party organization to manage players, employees, officials, etc. of interest.)
(g) An influencer could use the system (as a user) and could run a brand safety report on him or herself as a preventative measure to ensure nothing from posts made in the past which may be a flag remains unexplained, deleted, or mitigated. Similarly, parents could analyze and get score results related to their children's social media accounts.
(h) A brand manager may use the system to assist in determining whether a person, e.g., influencer of interest may be compatible with their brand, which may be referred to as brand matching. Brand matching may implement an algorithm based on audited characteristics of interest, and detailed analytics which may be pulled from other systems. A matching algorithm may compute a percentage match based off of criteria a brand may specify manually, or criteria selected, deciphered, or derived from data. The results of such algorithm may be communicated to the user.
(i) The system may be used for authenticating the credibility of a particular social media personality, celebrity or influencer, characterizing and scoring emotive elements or disinformation elements or any other elements of interest in influencer posts, stability of style or message, and other categories of posts of interest.
(j) A studio casting for movies or television shows may use the system for looking back through the history of particular individuals, such as potential talent, or any other accounts or influencers of interest. The system can also be used for monitoring the talent going forward.

### Workflows

The method may include a user interface 400, which may be accessible from a user's device. The user interface may include an accounts section 410, which may display a safety profile badge 412 next to an account name of the third party.

This may be applicable for accounts that have the system's brand monitoring function enabled, and therefore may have a safety profile associated with their account within the system. Third party customers may purchase enough system credits which can then be consumed when media is analyzed, providing a metered-payment system in an ongoing manner.

### Workflow Case #1:

The system may allow a third party end user to enable an account associated with an influencer of interest to be monitored, along with the monitoring duration and the platforms targeted for monitoring of the influencer.

### Workflow Case #2:

From the system's web application menu, the user may be able to access an accounts section. From the list of accounts/influencers provided there (prepopulated by the user's prior configuration of the system), the user can click on a badge or interface element and navigate to the account monitoring profile associated with that user and that influencer.

With reference to FIG. 8, the monitoring profile may display a safety analysis report 242′, which may include analysis of data from selected rich media posted by the influencer within time and media limits preselected by the end-user. In this example, there are 10 “explicit” categories the percentage of incidence of which when the influencer's selected media posts are characterized by the system is measured by the system for the content elements analyzed:
(a) Adult
(b) Suggestive
(c) Visually disturbing
(d) Violent
(e) Drugs, Tobacco, Alcohol
(f) Rude Gestures
(g) Gambling
(h) Hate Symbols
(i) Racy
(j) Gory
(k) Profanity
(l) Banned Words
   (i) These banned words may be red-flag words the user has identified as banned or taboo for this third party's influencers.

### Workflow Case #3:

From the system's web application menu, the user may be able to access a brand monitoring module. In one embodiment, by default, if the user's organization has a standard or default criteria or category set for media characterization already set up (under the user's organization settings preconfigured by an admin user, for example), the system may list one or more influencer accounts as previously configured, in a descending order, of criteria or category characterization match percentages or scores.
(a) The user can filter further by updating any default filter criteria (which may be within the user's organization's brand matching criteria set under a settings section of the user interface).
(b) The user can click on an influencer's or account's badge and navigate to the that influencers' account's safety profile.
   (i) In addition to an explicit content summary, details and other optional sections, an additional section which might be referred to as a “brand criteria” sub-section may also be displayed. This section or the system's output interface with the user may list a “safety score,” which may be inversely proportional to the presence and volume of explicit content characterized and detected in the influencer's analyzed content. An example description of the safety score calculation is documented below.

### Safety Analysis Report

FIGS. 9 and 10 illustrate examples of metrics that may be displayed in a monitoring report 242″.

### Safety Score Calculation

In this example, a “safety score” reflects the percentage of media content posts by the influencer that do not contain any explicit and profanity content.

Below are example input parameters:
(a) Explicit content percentage=(posts with explicit content/total posts)*100
(b) Profanity percentage=(posts with profanity/total posts)*100
(c) Safety score %=100−(average of (explicit content percentage+profanity percentage))

Example definition of posts characterized and scored as containing explicit content—The system may run Azure/AWS API's against each selected influencer's content or posted media from an initial media search (or series of searches), in this example, image and/or video, to identify and characterize whether the post had explicit content. This may include audio recognition, optical character recognition, and other methods used to convert audio, video, and imagery into text. Such text may then be further analyzed. If the post was identified with explicit content, characterized and considered as an explicit post. The score may be computed using one or more algorithms.

Example definition of posts characterized and scored as containing profanity—The system may be configured to check for profane words in a selection of influencer media posts by characterizing the post title, text, text in images/videos and text transcribed from audio (for example). If any of the identified text has a profane word in it (by comparison with a listing of profane words or text), then the post may be flagged under the profanity category.

Example of a safety score calculation:
(a) Let total posts=1000
(b) Total posts labelled under explicit=200
(c) Total posts labelled under profanity=300
(d) Explicit content percentage=(200/1000)*100=20%
(e) Profanity percentage=(300/1000)*100=30%
(f) Safety score=100−((20+30)*0.5)=75%

### Search

A method for conducting a search of social media profiles may include indexing one or more social media profiles, including storing data associated with each of the profiles in a relational database of a computer; establishing a communication link with a user device; receiving, from the user, a query; processing the query, including preparing a list of profiles related to the query; and displaying the list to the user device.

A method 100 for indexing social media activity is provided. The method 100 may include sorting, indexing, and ranking social media profiles. The method 100 may index profiles, other social media activity, or both. Other social media activity may include, for example, a user's interests. The method 100 may index a particular social media platform, such as Instagram™, or the method may index any number of social media platforms, such as Instagram™, Facebook™ YouTube™, and Pinterest™. In one embodiment, method 100 may include indexing 120 of one or more social media profiles. Indexing may include storing data associated with each of the profiles in a relational database of a computer. Method 100 may further include establishing 130 a communication link with a user device; receiving 140, from a user, a query; processing 150 the query, and communicating 160 the results of the query to the user device. Processing 150 may include compiling a subset of the data, the subset being selected and ranked according to their relevance to the query; and preparing a list of profiles from the subset, the list including a hyperlink to each profile of the list of profiles.

The method 100 may index business profiles, activity performed by such profiles, or both. On many search engines, profiles can be set to private or public. A private profile may have limited ability to be indexed. Public profiles, on the other hand, are generally capable of being indexed. On some social media platforms, such as Instagram™, business profiles are always public.

The method 100 may include storing data to a database. Such data may include any one or more of the following attributes associated with each social media profile that is indexed:
(a) Social media platform;
(b) Social media handle name;
(c) Social media user content, such as the user's biography or “bio” as it is known on Instagram™;
(d) User location, which may include a location mentioned in the user's bio or other social media user content;
(e) Website;
(f) Email address;
(g) Previous posts, or a subset of previous posts, for example the most recent 50 posts;
(h) Previous posts may be analyzed using one or more of the following:
   (i) Image recognition,
   (ii) Video recognition,
   (iii) Voice recognition,
   (iv) Caption,
   (v) Tagged location, and
   (vi) Comments; and
(i) The profile may be analyzed using one or more of the following:
   (i) Audience authenticity,
   (ii) Customer sentiment,
   (iii) Engagement rate,
   (iv) Date page was created,
   (v) How frequently the profile makes posts,
   (vi) Audience growth over time,
   (vii) Follower ratios, such as how many followers the profile has compared to how many other pages the profile follows, and
   (viii) Bookmarked and saved content.

In one embodiment, the method may also consider information provided by the person controlling the social media page to the person carrying out the method. Such information may be communicated by email or other means. This may allow the business associated with the social media page to pay for additional features such as being ranked higher on search results.

In one embodiment, the method may filter results based on information about the user. For example, the user may provide demographic information, such as their location, and the list of results may be ranked, among other factors, based on proximity to the user. In another embodiment, information about the user may be captured from disparate sources. For example, the user's location may be captured from their own social media profile, from public directories such as phone books, etc.

The method may be carried out as instructions performed by a computer. The method may be a computer application. The method may be carried out through a web browser and be performed by a remote server in communication with the web browser. The method may be implemented as a web-browser extension. The method may include establishing a communications channel with a user. The user may then submit a query for the method to analyze, and the method may then provide the user with results based on the query.

The query may include a string of text. The results may include a list of social media profiles and hyperlinks to the given profile that are related to the query based on the index of social media profiles described above.

By way of illustrative example, without limitation, queries may include:
(a) “Restaurants near me”;
(b) “Baby clothes”;
(c) “Kids daycare near me”;
(d) “Contemporary painter”;
(e) “Companies like Robinhood”;
(f) “Sports tickets”;
(g) “Best jewelers”;
(h) “Insurance brokers”;
(i) “Taco spots near me”;
(j) “Nail salon”; and
(k) “New York city eye clinic”.

A user may refine the results by geographic proximity to a desired location, by either a ZIP/postal code, city, state, or province. The user may further refine the results by social media platform.

The results may be displayed with the following elements:
(a) A preview of the profile, including a link to the profile;
(b) Ability to refine results to achieve desired outcome.

The type of hyperlink to the profile may be selected based on the user's device. For example, if the user is using a mobile device such as a cell phone, the mobile version of the profile may be associated with the hyperlink.

Users may allow users to rank their experiences with the method, and rank the profiles that the method indexes. Users may suggest favourite businesses, and users may be compensated with credit to incentivize such behaviour. Users may be able to create networks or groups, for example, based on one or more of: industry, interest, geography, and other criteria. For example, such criteria may include whether the business associated with the profile is environmentally-friendly. If the business serves food, such criteria may include whether the business caters to vegan diets.

Businesses may submit information associated with their profile, including location, hours of operation, contact information, similar companies, etc.

Certain aspects of the method may be available free of charge to users and businesses. Other aspects of the method may require payment. For example, the results may be displayed with ads that are purchased by businesses. Businesses may purchase memberships or pay other fees to have access to certain features.

In addition to business profiles, other profiles can be indexed. For example, profiles associated with certain interests may be indexed and users may be able to search and obtain a list of profiles associated with such interests. Such interests may include, for example: celebrities and business leaders, how to cook a roast, orange is the new black, best movies, etc.

In interviews with millennials, 9/10 said they preferred the method 100 and its associated apparatus over conventional search engines such as Google™.

The method may include one or more of the following:
(a) An interface for a third party, which may be bi-directional;
(b) At least one search mechanism to find and get a link to at least one influencer post of content or to at least one post with content about an influencer;
(c) At least one content analysis mechanism to characterize the content using categories previously selected by the third party using the third party interface, providing a content characterization;
(d) A comparator to compare the content characterization with criteria selected by the third party to provide a score indicative of some measure of the criteria found in the analyzed content; and
(e) An output from the comparator comprising a feedback to the third party indicative of the degree of fit between the content characterization score obtained by the comparator with a score preselected by the third party which preselected score might be an idealized score or an acceptable range limit or an unacceptable range limit of scores within that category of characterization, which was preselected by the third party using the interface; and
(f) At least one of the content analysis mechanism, category description and associated filter or search parameters, scoring means, comparator means and means to determine degree of fit or idealized score or range limit of score, may be done by or informed by or augmented by machine learning processes or systems; and
(g) At least one content analysis mechanism to feed the output to a prediction or recommendation model built using machine learning; and
(h) A mechanism that provides templates to configure content analysis confidence scores, or other content characterization metrics, to provide more context of analyzed content.

The method may be configured as an automated social media background checking and reporting system.

The method may implement any one or more of: artificial intelligence, machine learning, natural language processing, and/or automated image processing.

A computer-implemented method 200 of analyzing data from social media is provided. Method 200 may include: receiving 210, by a computer 212, a reference to a social media profile 300; collecting 220 data 310 about social media profile 300; processing 230 the data on the computer using an algorithm 232; generating 240 a report 242 of the results of said processing; and communicating 250 the report to a user device 214, e.g., via a network 216 which may include an internet connection. Communicating may include causing the report to be displayed on a screen. Further, or in the alternative, communicating may include notifying the user of the report and/or updates thereto, for example, via email.

Processing 230 may be performed by a first computer, and communicating may include communication to a remote device of a user. For example, the first computer may be a dedicated server, and the remote device may be a cell phone of the environment. The method may include establishing a communication link between the remote device and the first computer. The method may include receiving parameters 320 of interest from the user. Processing may include comparing the data 310 with the parameters 320. Generating may include calculating a score 330, which may be included in the report. Multiple scores may be included. For example, a safety score may indicate the percentage of explicit posts associated with the profile, and a brand fit score may indicate the percentage of posts associated with the profile that are directed to content relevant to the user's brand. The method may include receiving or determining data related to content that is relevant to the user's brand. The user may be able to submit information, e.g., key words, that are relevant to the user's brand, which may be used for the purposes of such analysis.

The method may be configured to run constantly and/or periodically, and notify the user, e.g., at regular intervals or on certain events, such as a safety score moving outside an acceptable range, which may be adjusted by the user via the user interface. The user may be able to determine the frequency of monitoring, e.g., daily, weekly, etc. In one embodiment, monitoring of a profile may be communicated and/or managed via a monitoring tab of the user interface.

The report may include a badge. The badge may be indicative of the social media profile having a safety score within the acceptable range. The user may implement the method on multiple social media profiles at once, and may be able to view any one or more of such profiles via the same user interface. Via the user interface, the user may be able to navigate to a particular social media profile being analyzed.

The report may include various criteria of interest. For example, the report may show the percentage of posts containing rude gestures, or any number of so-called explicit categories of content. The user may be able to create custom explicit categories, for example, by submitting a set of banned words. The report may be displayed via a user interface. The user interface may include a search mechanism. The report may include one or more links, for example, to the social media profile and/or particular posts.

Multiple social media profiles may be associated. For example, the same influencer may have a first social media account of a first platform, and a second social media account of a second platform. One or more media sources, which may include the first social media account and the second social media account, including subsets (e.g., portions of such accounts) thereof, may be selected by the user via a media sources tab 244 the user interface. The method may perform analysis on both accounts and aggregate analysis into the same report.

The method may include a content analysis mechanism, which may feed the output of processing to a prediction and/or recommendation model, which may be built using machine learning. The method may include a mechanism that may provide templates to configure content analysis confidence scores, or other content characterization metrics, to provide more context of analyzed content.

### Clauses

Clause 1. A computer-implemented method of analyzing data from social media, comprising: receiving, by a computer, a reference to a social media profile; collecting data about the social media profile; processing the data on the computer using an algorithm; generating a report of results of said processing; and communicating the report to a user.

Clause 2. A method for conducting a search of social media profiles, comprising: indexing one or more social media profiles, including storing data associated with each of the profiles in a relational database of a computer; establishing a communication link with a user device; receiving, from a user, a query; processing the query, including compiling a subset of the data, the subset being selected and ranked according to their relevance to the query; and preparing a list of profiles from the subset, the list including a hyperlink to each profile of the list of profiles; and communicating the list to the user device.

Clause 3. The method of any one or more of the clauses, further comprising: generating user information about the user, including one or both of collecting information from the user and about the user from the Internet; and processing includes further selecting and ranking the subset according to the user information.

Clause 4. A system for analyzing data from social media, comprising: a computer for receiving a reference to a social media profile; the computer being configured to collect data about the social media profile, process the data using an algorithm, generate a report of results of said process; establishing a communication link to a user device; and communicating the report to the user device via the communication link.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A computer-implemented method of analyzing data from social media, comprising:
receiving, by a computer, a reference to a social media profile;
collecting data about the social media profile;
processing the data on the computer using an algorithm;
generating a report of results of said processing; and
communicating the report to a user.

2. A method for conducting a search of social media profiles, comprising:
indexing one or more social media profiles, including
storing data associated with each of the profiles in a relational database of a computer;
establishing a communication link with a user device;
receiving, from a user, a query;
processing the query, including
compiling a subset of the data, the subset being selected and ranked according to their relevance to the query; and
preparing a list of profiles from the subset, the list including a hyperlink to each profile of the list of profiles; and
communicating the list to the user device.

3. The method of claim 2, further comprising:
generating user information about the user, including one or both of collecting information from the user and about the user from the Internet; and
processing includes further selecting and ranking the subset according to the user information.

4. A system for analyzing data from social media, comprising:
a computer for receiving a reference to a social media profile;
the computer being configured to
collect data about the social media profile,
process the data using an algorithm,
generate a report of results of said process;
establishing a communication link to a user device; and
communicating the report to the user device via the communication link.
